(19) United States
(12) Patent Application Publication
(10) Pub. No.: US 2014/0008994 A1
(43) Pub. Date: Jan. 9, 2014

(54) POWER MANAGEMENT DEVICE, POWER SUPPLY DEVICE, POWER SUPPLY SYSTEM, POWER MANAGEMENT METHOD, AND POWER SUPPLY METHOD

(71) Applicant: Sony Corporation, Tokyo (JP)

(72) Inventors: Takanori Washiro, Kanagawa (JP); Taro Tadano, Chiba (JP); Kazuyoshi Takemura, Tokyo (JP); Kuniya Hayashi, Tokyo (JP); Kayoko Tanaka, Tokyo (JP); Yoichiro Sako, Tokyo (JP); Kazutoshi Serita, Tokyo (JP)

(73) Assignee: Sony Corporation, Tokyo (JP)

(21) Appl. No.: 13/930,103

(22) Filed: Jun. 28, 2013

(30) Foreign Application Priority Data
Jul. 6, 2012 (JP) 2012-152888

(51) Int. Cl. H02J 4/00

(52) U.S. Cl. CPC H02J 4/00
USPC 307/104; 307/116

(57) ABSTRACT

There is provided a power management device including a storage unit configured to hold a correspondence relationship between first identification information held by a power supply target and second identification information held by a user in advance, and a power management unit configured to issue a power supply instruction to a power supply device that supplies power to the power supply target based on the correspondence relationship between the first identification information and the second identification information.

### BACKGROUND

The present disclosure relates to a power management device, a power supply device, a power supply system, a power management method, and a power supply method.

Recently, with the increased interest in energy problems, a management device capable of controlling the supply of power to an electronic device connected to a power feed device or the like has been proposed for the purpose of security enhancement, convenience improvement of power use, efficiency of power use, and the like (Japanese Unexamined Patent Application Publication No. 2010-182239).

### SUMMARY

The technology disclosed in Japanese Unexamined Patent Application Publication No. 2010-182239 achieves security enhancement and application improvement by permitting charging to a storage battery of a plug-in vehicle when the plug-in vehicle has an electronic authentication key.

However, in the technology disclosed in Japanese Unexamined Patent Application Publication No. 2010-182239, because the electronic authentication key indicating the authority to charge is provided in the plug-in vehicle, for example, it is difficult to control a determination of permission or rejection of charging based on an event or the like at a position away from the plug-in vehicle. Consequently, an available situation is limited.

It is desirable to provide a power management device, a power supply device, a power supply system, a power management method, and a power supply method capable of supplying power only to a specific power supply target having the right to use power in a wide range of situations.

According to a first embodiment of the present technology, there is provided a power management device including a storage unit configured to hold a correspondence relationship between first identification information held by a power supply target and second identification information held by a user in advance, and a power management unit configured to issue a power supply instruction to a power supply device that supplies power to the power supply target based on the correspondence relationship between the first identification information and the second identification information.

Further, according to a second embodiment of the present technology, there is provided a power supply device including an information acquisition unit configured to acquire first identification information held by a power supply target, an inquiry unit configured to issue an inquiry of permission/rejection of power supply for the power supply target to a power management device based on the first identification information, and a power supply unit configured to supply power to the power supply target according to a power supply instruction from the power management device in response to the inquiry.

Further, according to a third embodiment of the present technology, there is provided a power supply system including a power management device, and a power supply device. The power management device may include a storage unit configured to hold a correspondence relationship between first identification information held by a power supply target and second identification information held by a user in advance, and a power management unit configured to issue a power supply instruction to the power supply device that supplies power to the power supply target based on the correspondence relationship between the first identification information and the second identification information. The power supply device may include an information acquisition unit configured to acquire the first identification information held by the power supply target, an inquiry unit configured to issue an inquiry of permission/rejection of power supply for the power supply target to the power management device based on the first identification information, and a power supply unit configured to supply power to the power supply target according to the power supply instruction from the power management device in response to the inquiry.

Further, according to a fourth embodiment of the present technology, there is provided a power management method including holding a correspondence relationship between first identification information held by a power supply target and second identification information held by a user in advance, and issuing a power supply instruction to a power supply device that supplies power to the power supply target based on the correspondence relationship between the first identification information and the second identification information.

Further, according to a fifth embodiment of the present technology, there is provided a power supply method including acquiring first identification information held by a power supply target, issuing an inquiry of permission/rejection of power supply for the power supply target to a power management device based on the first identification information, and supplying power to the power supply target according to a power supply instruction from the power management device in response to the inquiry.

According to the embodiments of the present technology described above, it is possible to supply power only to a specific power supply target having the right to use power.

### BRIEF DESCRIPTION OF THE DRAWINGS

FIG. 1 is a block diagram illustrating a configuration of a power supply system according to an embodiment of the present technology;

FIG. 2 is a block diagram illustrating a configuration of a power supply device;

FIG. 3 is a block diagram illustrating a configuration of a power management device;

FIG. 4 is a diagram illustrating a process to be performed by the power supply system;

FIG. 5 is a block diagram illustrating a configuration of a first application example of the power supply system according to an embodiment of the present technology;

FIG. 6 is a block diagram illustrating a configuration of a second application example of the power supply system according to an embodiment of the present technology;

FIG. 7 is a flowchart illustrating the flow of a process in the second application example of the power supply system; and

FIG. 8 is a flowchart illustrating the flow of a second process in the second application example of the power supply system.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, an embodiment of the present technology will be described with reference to the appended drawings. However, the present technology is not merely limited to the following embodiment. Also, description will be given in the following order.

<1. Embodiment>

[1-1. Configuration of power supply system]

[1.2. Process in power supply system]

<2. First application example of power supply system>

<3. Second application example of power supply system>

<4. Modified examples>

### 1. Embodiment

### 1-1. Configuration of Power Supply System

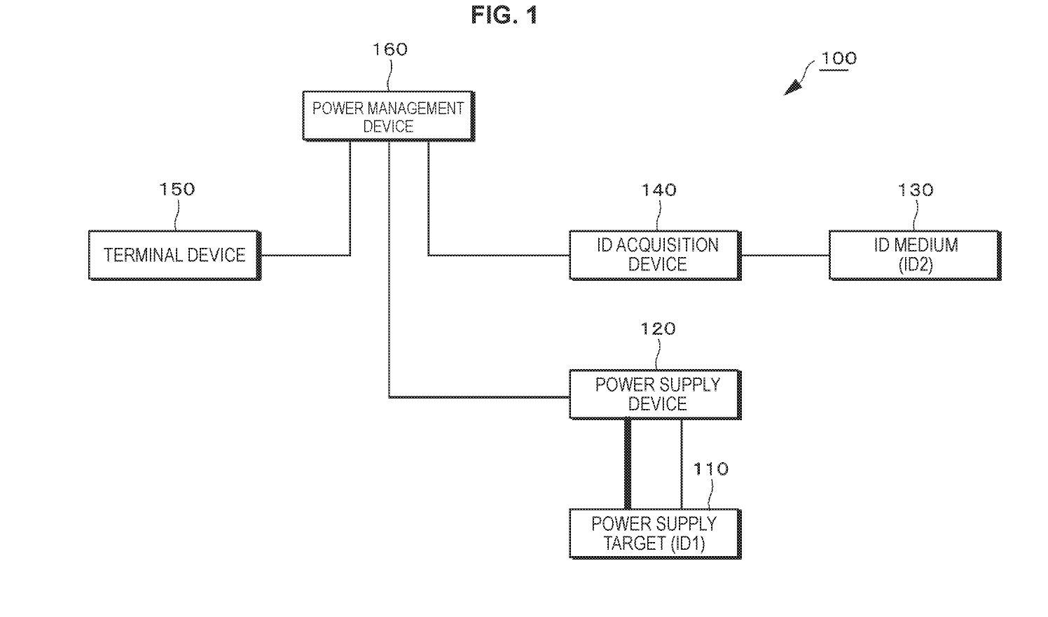

FIG. 1 is a block diagram illustrating a configuration of the power supply system 100 including a power supply device 120 and a power management device 160 according to an embodiment of the present technology. The power supply system 100 includes a power supply target 110, the power supply device 120, an identifier (ID) medium 130, an ID acquisition device 140, a terminal device 150, and the power management device 160.

The power supply target 110 receives the supply of power from the power supply device 120. An example of the power supply target 110 is electric equipment, an electric vehicle (EV), a home appliance, or the like having a battery. As the battery, any one capable of performing charging and discharging such as a lithium ion secondary battery, a lithium ion polymer secondary battery, or a nickel hydride battery may be adopted.

The power supply target 110 has ID1 as identification information. ID1 corresponds to first identification information in the claims. ID1, for example, is written to an integrated chip (IC) chip provided in the power supply target 110, and is a model number, a serial number, or the like of equipment, a battery, and a device serving as the power supply target 110. However, as long as ID1 is unique to each power supply target 110, an arbitrary character string or the like may be used instead of the model number and the serial number.

Also, when there are a plurality of power supply targets 110, for example, different ID1 such as ID1a, ID1b, and ID1c is assigned to an individual battery, equipment, and a device.

The power supply device 120 supplies power to the power supply target 110. A bold line connected between the power supply device 120 and the power supply target 110 illustrated in FIG. 1 represents a power line for power supply.

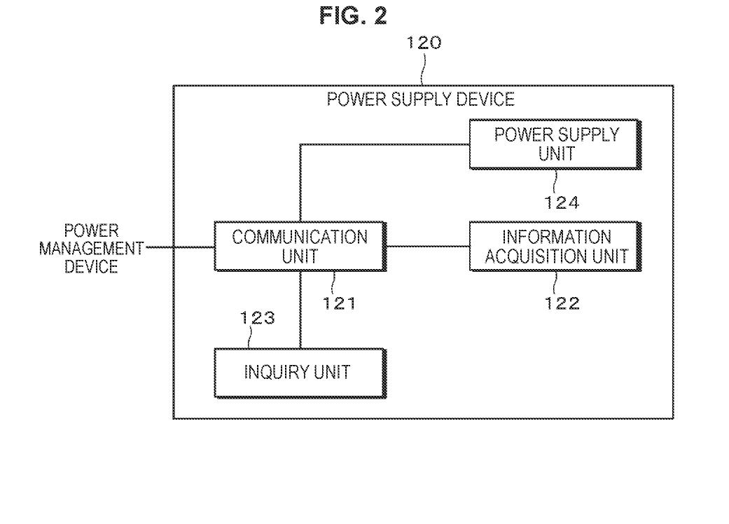

Here, a configuration of the power supply device 120 will be described with reference to FIG. 2. The power supply device 120 includes a communication unit 121, an information acquisition unit 122, an inquiry unit 123, a power supply unit 124, and the like.

The communication unit 121, for example, is a network interface for communicating with the terminal device 150 and the power supply device 120 via a network such as the Internet or a dedicated line based on a predetermined protocol. A communication scheme may be any one of wired communication, communication using a wireless local area network (LAN), wireless fidelity (Wi-Fi), a third generation (3G) network, or a fourth generation (4G) network, and the like.

The information acquisition unit 122 acquires ID1 that is identification information of the power supply target 110 connected to the power supply device 120. The information acquisition unit 122, for example, is an authentication type outlet. In the authentication type outlet, there are a non-contact IC card type, a power line superimposition communication type, and the like.

The non-contact IC card type is a scheme using an information reading mechanism in a non-contact IC card. A reader/writer for IC reading/writing is provided in an outlet of the power supply device 120, and an IC chip to which ID1 is written is embedded in a plug of a battery or an outlet of equipment or a device equipped with the battery. Thereby, when the plug of the battery is inserted into the outlet of the power supply device 120, the IC chip and the reader/writer is in proximity so that communication is possible and ID1 is readable.

The power line superimposition communication scheme is a scheme of reading ID1 written to the IC chip provided in the battery or equipment provided with the battery through a high frequency signal of the reader/writer superimposed on a power line for power supply.

In the present technology, any scheme described above may be adopted. In addition, any scheme having a mechanism capable of reading information when an outlet for charging is connected may be adopted in addition to the above-described two schemes.

The inquiry unit 123 inquires the power management device 160 about whether power supply to the power supply target 110 having ID1 acquired by the information acquisition unit 122 is possible via the communication unit 121. The inquiry unit 123, for example, iteratively inquires the power management device 160 at a predetermined time interval such as an interval of several minutes until the power supply to the power supply target 110 is started or until a connection between the power supply target 110 and the power supply device 120 is disconnected without power supply. A frequency of the inquiry may be predetermined or arbitrarily set by a business operator or the like who operates the power supply system 100.

The power supply unit 124 is configured to include a rectifying circuit, a charging circuit, a charging terminal, and the like, and performs a charge operation on the power supply target 110. For example, the rectifying circuit generates direct current (DC) power by rectifying alternating current (AC) power, and the charging circuit supplies the DC power supplied from the rectifying circuit to the power supply target 110 via a power supply terminal of the authentication type outlet.

It is only necessary that the power supply unit 124 integrally constitute the authentication type outlet along with the information acquisition unit 122. Thereby, it is possible to acquire ID1 from the power supply target 110 and supply power to the power supply target 110 by merely connecting the authentication type outlet to the power supply target 110. Also, as the power supply, power supply using non-contact power feeding technology by transmitting power without a metal contact point, a connector, or the like as well as wired power supply by a connection of a terminal may be performed. The non-contact power feeding is power transmission technology using wireless power feeding, non-contact power transfer, or electromagnetic induction also referred to as non-contact power transmission or the like.

The description will now return to the power supply system 100 of FIG. 1. The ID medium 130 is a medium having ID2, which is identification information. ID2 corresponds to second identification information in the claims. As the ID medium 130, for example, there is a credit card, a membership card of a video rental shop, a medical care card of a medical institution, or the like possessed by a user. In addition, information regarding the user himself/herself such as a user name, a character string arbitrarily determined by the user, or the like may be ID2.

The ID acquisition device 140 acquires ID2. For example, when ID2 is related to a credit card, a membership card of a video rental shop, a medical care card of a medical institution, or the like, the ID acquisition device 140 is a card reader. In addition, when ID2 is a character string such as a user name, the ID acquisition device 140 serves as the terminal device 150 or the like that receives an input of the character string. The ID acquisition device 140 is connected to the power management device 160 via a network or the like, and transmits the acquired ID2 to the power management device 160.

The terminal device 150 is used by the user. For example, the terminal device 150 is a personal computer, a notebook computer, a portable telephone, a smart phone, or the like. The terminal device 150 is connected to the power management device 160 via a network or the like. The terminal device 150 transmits information indicating that ID1 and ID2 are associated to the power management device 160. For example, the information indicating that ID 1 and ID2 are associated is created by the user.

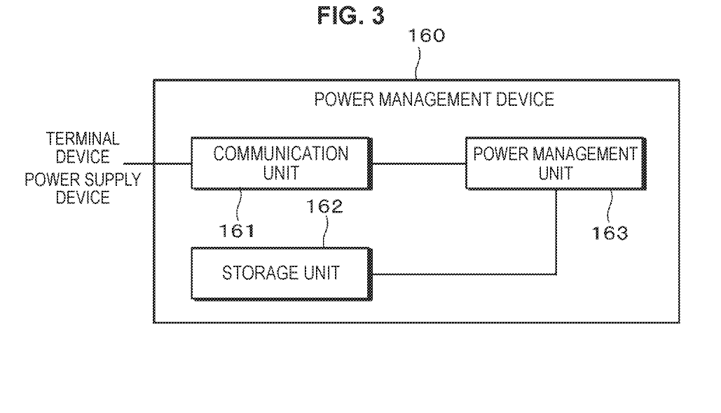

The power management device 160 is a server device or the like that performs a power management process according to an embodiment of the present technology. FIG. 3 is a block diagram illustrating a configuration of the power management device 160. The power management device 160 includes a communication unit 161, a storage unit 162, and a power management unit 163.

The communication unit 161, for example, is a network interface for communicating with the terminal device 150 and the power supply device 120 via a network such as the Internet or a dedicated line based on a predetermined protocol. A communication scheme may be any one of wired communication, communication using a wireless LAN, Wi-Fi, a 3G network, or a 4G network, and the like.

The storage unit 162 is a storage medium including a hard disk, a flash memory, or the like. The storage unit 162 functions as an ID database in which an association relationship between ID1 and ID2 is stored and held. Upon receiving information transmitted from the terminal device 150 indicating a relationship in which ID1 and ID2 are associated, the power management device 160 stores the association relationship between ID1 and ID2 in the storage unit 162 based on the information.

The power management unit 163, for example, includes a central processing unit (CPU), a random access memory (RAM), a read only memory (ROM), and the like, and is a processing unit configured to perform a power management process according to an embodiment of the present technology by executing a predetermined program.

Upon receiving ID2 transmitted from the ID acquisition device 140, the power management unit 163 grants the right to charge to ID2 and records information indicating the right grant on the storage unit 162.

In addition, when there is an inquiry of whether power supply to the power supply target 110 having ID1 is possible from the power supply device 120, the power management unit 163 refers to the storage unit 162 and checks whether the right to charge is granted to ID2 associated with ID1. Accordingly, when the right to charge is granted to ID2 associated with ID1, a power supply instruction for the power supply target 110 is provided to the power supply device 120. On the other hand, when the right to use power is not granted to ID2 associated with ID1, an instruction indicating that power supply is not performed is issued to the power supply device 120.

The power supply system 100 is configured as described above.

### 1-2. Process in Power Supply System

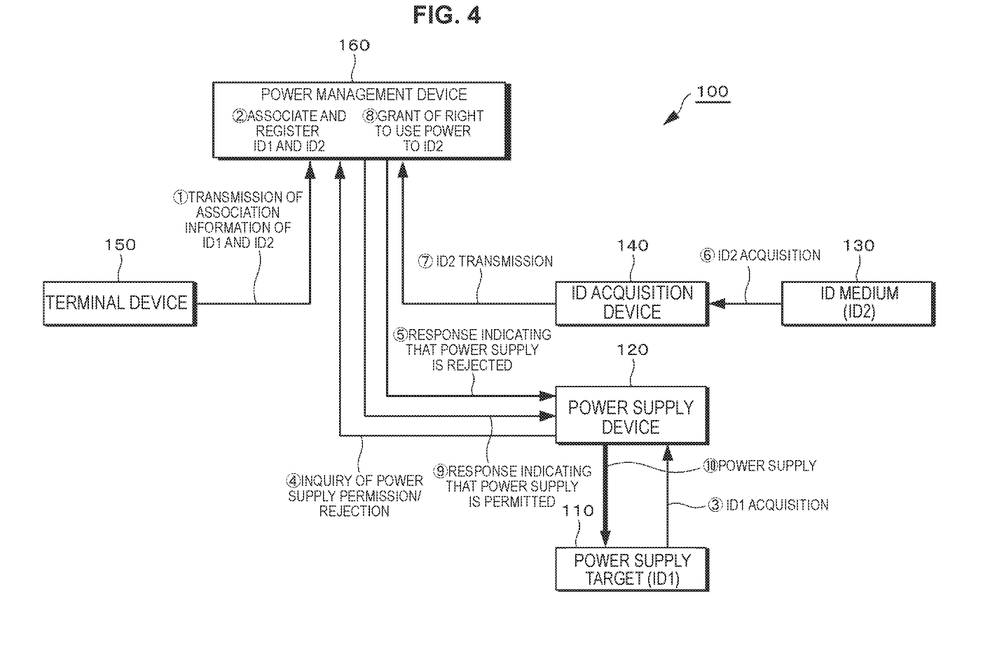

Next, the process in the power supply system 100 will be described. FIG. 4 is a diagram illustrating a process to be performed in the power supply system 100. First, in step 1, information indicating ID1 and ID2 associated with ID1 is transmitted from the terminal device 150 to the power management device 160. This, for example, is performed when the user operates the terminal device 150. Accordingly, in step 2, the power management device 160 registers that ID1 and ID2 are associated in its own storage unit 162.

Next, when the power supply target 110 is connected to the power supply device 120, the information acquisition unit 122 of the power supply device 120 such as the authentication type outlet acquires ID1 held by the power supply target 110 in step 3. Accordingly, in step 4, an inquiry of whether the acquired ID1 is an ID for which power supply is possible is issued to the power management device 160 under the process of the inquiry unit 123 of the power supply device 120. Also, the inquiry of the power supply device 120 is continuously iterated at a predetermined time interval until the power supply to the power supply target 110 is started or until a connection between the power supply device 120 and the power supply target 110 is disconnected without power supply.

For the inquiry from the power supply device 120, the power management device 160 transmits a response of power supply permission/rejection to the power supply device 120 in step 5. When there is an inquiry from the power supply device 120, the power management unit 163 of the power management device 160 checks whether the right to use power is granted to ID2 associated with ID1 that is an inquiry target. Accordingly, when the right to use power is not granted to ID2, the power management device 160 transmits a response indicating that power supply is not possible to the power supply device 120. This response is performed every time there is an inquiry from the power supply device 120. The response indicating that the power supply is not possible is made until the right to charge is granted to ID2.

Thereafter, in step 6, the ID acquisition device 140 acquires ID2 from the ID medium 130. This, for example, is performed when the user shops using a credit card 230 and a card reader or the like reads a card number of the credit card 230 if the card number of the credit card 230 functions as ID2. Accordingly, in step S7, ID2 acquired by the ID acquisition device 140 transmits the acquired ID2 to the power management device 160.

Next, in step 8, the power management unit 163 of the power management device 160 grants the right to use power to the received ID2, and records its contents on the storage unit 162. This, for example, indicates that only a user shopping with the credit card 230 is permitted to use the power.

Accordingly, after there is an inquiry from the power supply device 120 after the right to use the power has been granted to ID2 in step S8, the power management device 160 makes a response indicating that the power can be supplied to the power supply target as illustrated in step S9.

When there is an inquiry from the power supply device 120 as described above, the power management unit 163 of the power management device 160 checks whether the right to use the power is granted to ID2 associated with ID1 that is an inquiry target. Therefore, when an inquiry for permission/rejection of the power supply from the power supply device 120 is issued to the power management device 160 after the right to charge has been granted to ID2 in step 9, the power management device 160 issues a response indicating that the power supply is possible to the power supply device 120.

Accordingly, in step 10, the power supply unit 124 of the power supply device 120 supplies the power to the power supply target 110.

As described above, according to the present technology, it is possible to easily construct a system that supplies power only to a user satisfying a predetermined condition. In addition, for example, it is possible to manage the use of power by an ID even when a position at which ID2 is acquired is separated from the power supply device 120 configured to supply power. Thereby, it is possible to provide various services using the right to use electricity without limitations on a position, a distance, and the like.

### 2. First Application Example of Power Supply System

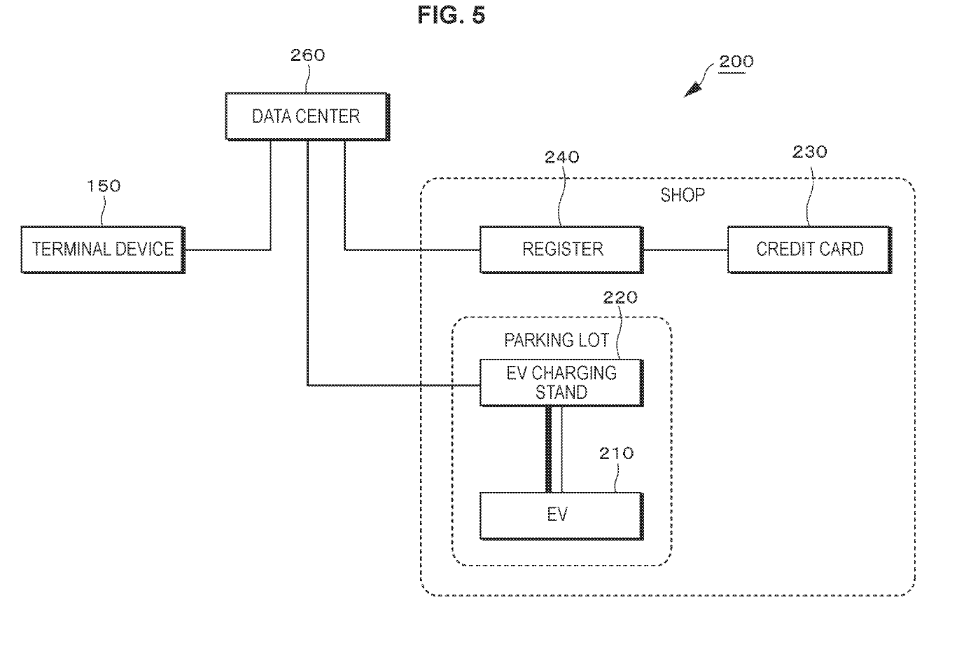

An example of a service using the power supply system will be described as an application example of the power supply system with reference to FIG. 5. In the power supply system 200 in the service, a power supply target is designated as an EV or a battery vehicle (the EV and the battery vehicle are collectively referred to as an EV 210 in the following description).

The EV 210 includes a battery configured to store power and is a vehicle that runs on a power driving force conversion device using the power stored in the battery. The EV 210 includes an outlet for charging the battery. This outlet can be connected to a plug of an EV charging stand 220, thereby charging the battery. The EV 210 has ID1. For example, an IC chip may be mounted on the EV 210 and ID1 may be written to the IC chip.

The EV charging stand 220 corresponds to the power supply device 120 described with reference to FIG. 1, and supplies power for charging to the battery of the EV 210. The EV charging stand 220 includes an authentication type outlet. As described above, in the authentication type outlet, there are a non-contact IC card type, a power line superimposition communication type, and the like. Thereby, the EV charging stand 220 reads ID1 held by the connected EV 210. The EV charging stand 220, for example, is provided in a parking lot of a shop or the like.

The credit card 230, for example, is possessed by the user who uses the EV 210, and a number of the credit card 230 functions as ID2. As described above, it is desirable to assign ID2 to one capable of being easily carried by the user.

The register 240 is a device used for fee payment or the like such as a cash register that includes a card reader configured to read ID2 in the credit card 230. The register 240, for example, is provided within the shop. The register 240 transmits the read ID2 to a data center 260 over a network or the like.

Like the example described with reference to FIG. 1, the terminal device 150, for example, is a personal computer, a notebook computer, a portable telephone, a smart phone, or the like. The terminal device 150 transmits information indicating that ID1 and ID2 are associated to the data center 260. For example, the information indicating that ID1 and ID2 are associated is created by the user.

The data center 260 has the same configuration as the power management device 160 in FIG. 1, and performs a power management process. The data center 260 communicates with the terminal device 150 and the EV charging stand 220 based on a predetermined protocol. A communication scheme may be any one of wired communication, communication using a wireless LAN, Wi-Fi, a 3G network, or a 4G network, and the like.

Upon receiving information indicating that ID1 and ID2 are associated from the terminal device 150, the data center 260 records the received information on its own storage unit. In addition, upon receiving ID2 transmitted from the register 240, the data center 260 grants the right to use power to ID2, and also records that ID2 has the right to use the power on the storage unit. Accordingly, a response of permission/rejection of the power supply is issued for an inquiry of whether the power can be used with ID1 from the power supply device 120.

When the user makes payment for shopping with the credit card 230 in the shop in the power supply system 200, the register 240 acquires ID2. ID2 is transmitted from the register 240 to the data center 260. Then, in the data center 260, the right to use power is granted to ID2. Accordingly, when the EV charging stand 220 inquires the data center 260 about permission/rejection of the power supply of ID1 of the EV 210 and the right to use the power is granted to ID2, a response indicating that the power supply is possible is issued to the EV charging stand 220. Accordingly, the EV charging stand 220 supplies power to the EV 210 and hence the EV 210 is charged.

As described above, according to the present technology, for example, it is possible to provide a service for permitting only a user who has shopped with the credit card in the shop to charge the EV using the charging stand.

### 3. Second Application Example of Power Supply System

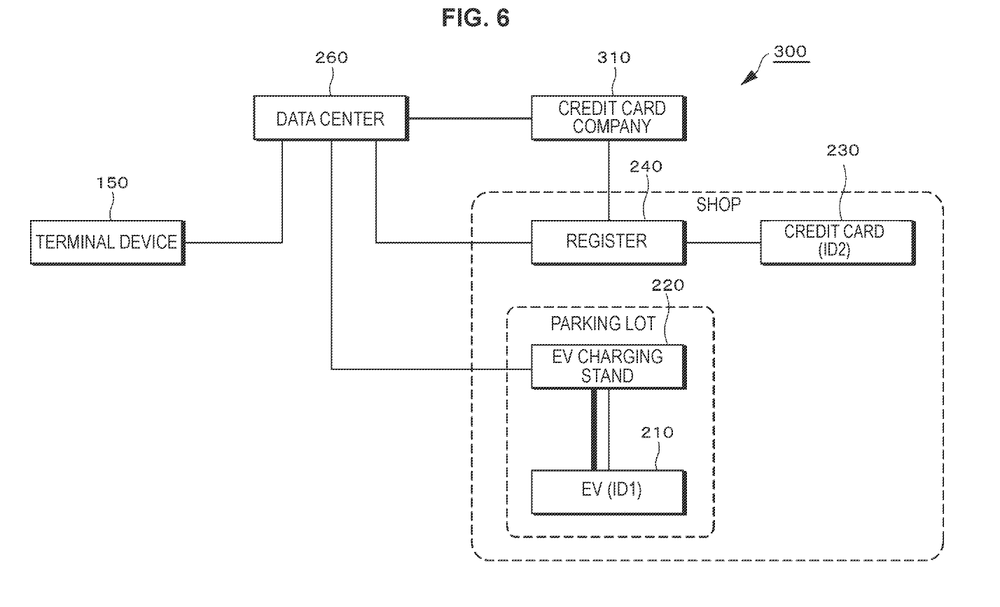

Next, the second application example of the present technology will be described. FIG. 6 is a block diagram illustrating a configuration of the power supply system 300 in the application example. Because configurations other than a credit card company 310 are substantially the same as those in FIG. 5, description thereof is omitted. The credit card company 310 is a business operator who performs issuance, management, payment, accounting, and the like for the credit card 230. In this application example, the user uses the EV 210, goes to a shop, and shops in the shop and a parking ticket is issued to the user according to the shopping in the shop.

Also, it is assumed that the EV charging stand 220 can supply power to the EV 210 and recognize a parking time of the EV 210 using a parking card, a sensor that senses the presence/absence of parking of the EV 210, or the like.

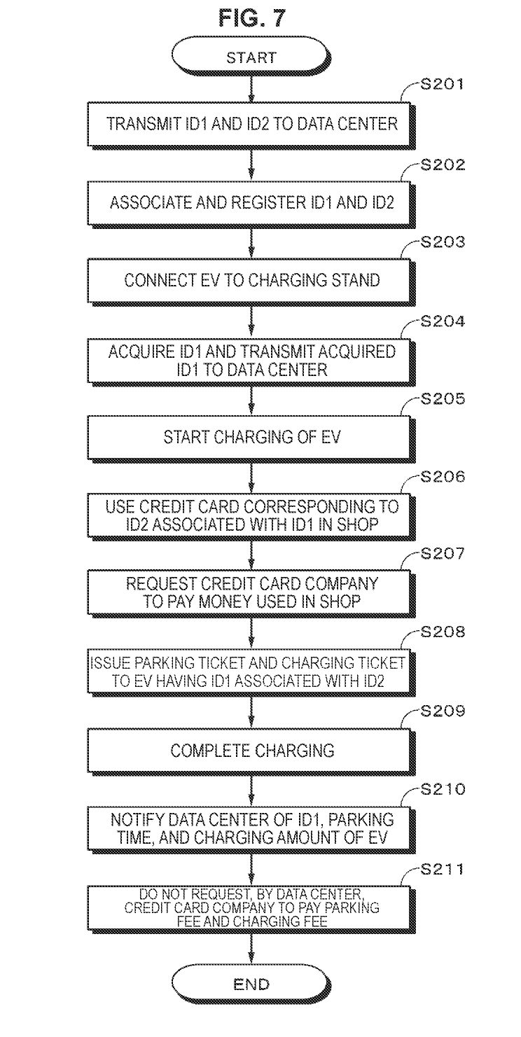

FIG. 7 is a flowchart illustrating the flow of a process in the application example of the power supply system 300. First, in step S201, the user transmits information indicating ID1 and ID2 associated with ID1 to the data center 260 using the terminal device 150. Next, in step S202, the data center 260 records that the received ID1 and ID2 are associated on its own storage unit 162.

Next, in step S203, the user goes to the shop using the EV 210 and connects the EV 210 to the EV charging stand 220. Accordingly, in step S204, the EV charging stand 220 reads ID1 of the EV 210 using an authentication type outlet, and transmits ID1 to the data center 260.

Next, in step S205, the EV charging stand 220 starts power supply (charging) for the EV 210. Next, in step S206, the user uses the credit card 230, which functions as ID2, in the shop.

Next, in step S207, the credit card company 310 is requested to pay money used with the credit card 230 of the user from the shop via the register 240. Next, in step S208, a parking ticket for verifying the right for parking and a charging ticket for verifying the right to charge are issued for ID1 associated with ID2.

Accordingly, when the EV 210 is fully charged or charged to a predetermined amount, charging of the EV 210 using the EV charging stand 220 ends in step S209. Next, in step S210, the EV charging stand 220 notifies the data center 260 of ID1, a parking time, and a charging amount of the EV 210 performing charging.

Accordingly, in step S211, the data center 260 does not request the credit card company 310 to pay a fee when the received ID1 of the EV 210 is ID1 for which the parking ticket and the charging ticket have been issued.

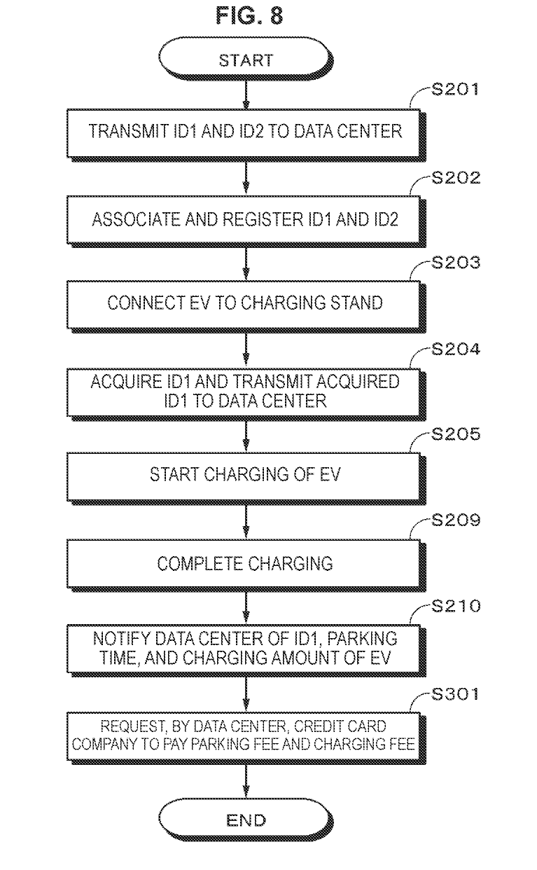

Next, a process in which a parking ticket or a charging ticket is not issued in a state in which payment is not made in the shop, that is, in a state in which the user does not shop therein, will be described with reference to the flowchart of FIG. 8. Also, because steps S201 to S205, step S209, and step S210 are substantially the same as in the flowchart of FIG. 7, description thereof is omitted. Because the user does not shop in the shop in the flowchart of FIG. 8, the process from step S206 to step S208 in FIG. 7 is not performed.

Because the parking ticket or the charging ticket is not issued from the data center 260 to the EV 210 in the flowchart of FIG. 8, the data center 260 requests the credit card company 310 to pay a parking fee or a charging fee based on ID1 received in step S210 in step S301.

As described above, according to the present technology, it is possible to construct a system capable of easily granting and referring to the “right to use electricity.” Further, it is possible to develop various services associated with the right to use the electricity.

For example, it is possible to provide a service for enabling only a user using facilities to which equipment using electricity such as charging is attached to use the electricity, a service for enabling only a user paying an electricity fee to use electricity, a service for enabling only a user performing membership registration to use electricity, and the like.

### 4. Modified Examples

Although the embodiment of the present technology has been specifically described above, the present technology is not limited to the above-described embodiment, and various modifications can be made based on a technical idea of the present technology.

In the above-described embodiment, the case in which the credit card possessed by the user functions as ID2 and the power supply target is an EV has been described. However, one functioning as ID2 is not limited to the credit card, and the power supply target is not limited to the EV. It is possible to implement various services by applying others.

For example, as a service to be provided in the facilities, a service for enabling only a user performing membership registration to use electricity can be implemented. When the membership registration is performed, a member ID is designated as ID2, the right to use the electricity is granted to ID2, and an association relationship of ID1 of electric equipment serving as the power supply target 110 to be used by a member is registered in ID2. The registration, for example, is performed by a server of an enterprise that provides the service. The facility includes a power supply device having an authentication type outlet and the authentication type outlet can read ID1 of the electric equipment in a connection state.

Accordingly, when the user connects the electric equipment to the authentication type outlet, the authentication type outlet reads ID1 of the electric equipment, and the power supply device inquires a server or the like about whether the electric equipment having ID1 can use electricity. Accordingly, when ID2 associated with ID1 has the right to use the electricity, power is supplied to the electric equipment by determining that the electric equipment having ID1 can use electricity.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) A power management device including:

a storage unit configured to hold a correspondence relationship between first identification information held by a power supply target and second identification information held by a user in advance; and

a power management unit configured to issue a power supply instruction to a power supply device that supplies power to the power supply target based on the correspondence relationship between the first identification information and the second identification information.

(2) The power management device according to (1), wherein the power management unit issues the power supply instruction by referring to the correspondence relationship between the first identification information and the second identification information in response to an inquiry of power supply permission/rejection for the power supply target issued from the power supply device.

(3) The power management device according to (1) or (2), wherein the power management unit grants a right to use power to the second identification information and issues the power supply instruction so that the power is supplied to the power supply target having the first identification information associated with the second identification information to which the right to use the power has been granted.

(4) The power management device according to any one of (1) to (3), wherein the first identification information and the second identification information are associated by the user in advance.

(5) The power management device according to any one of (1) to (3), wherein the second identification information is assigned to belongings of the user.

(6) The power management device according to any one of (1) to (3), wherein the second identification information is information regarding the user.

(7) A power supply device including:

an information acquisition unit configured to acquire first identification information held by a power supply target;

an inquiry unit configured to issue an inquiry of permission/rejection of power supply for the power supply target to a power management device based on the first identification information; and

a power supply unit configured to supply power to the power supply target according to a power supply instruction from the power management device in response to the inquiry.

(8) The power supply device according to (7), wherein the information acquisition unit acquires the first identification information using RFID over power line technology.

(9) The power supply device according to (7) or (8), wherein the information acquisition unit is integrated with the power supply unit.

(10) The power supply device according to any one of (7) to (9), wherein the power supply unit supplies the power to the power supply target using non-contact power feeding.

(11) A power supply system including:

a power management device; and

a power supply device,

wherein the power management device includes
a storage unit configured to hold a correspondence relationship between first identification information held by a power supply target and second identification information held by a user in advance, and
a power management unit configured to issue a power supply instruction to the power supply device that supplies power to the power supply target based on the correspondence relationship between the first identification information and the second identification information, and

wherein the power supply device includes
an information acquisition unit configured to acquire the first identification information held by the power supply target,
an inquiry unit configured to issue an inquiry of permission/rejection of power supply for the power supply target to the power management device based on the first identification information, and
a power supply unit configured to supply power to the power supply target according to the power supply instruction from the power management device in response to the inquiry.

(12) A power management method including:

holding a correspondence relationship between first identification information held by a power supply target and second identification information held by a user in advance; and

issuing a power supply instruction to a power supply device that supplies power to the power supply target based on the correspondence relationship between the first identification information and the second identification information.

(13) A power supply method including:

acquiring first identification information held by a power supply target;

issuing an inquiry of permission/rejection of power supply for the power supply target to a power management device based on the first identification information; and

supplying power to the power supply target according to a power supply instruction from the power management device in response to the inquiry.

The present disclosure contains subject matter related to that disclosed in Japanese Priority Patent Application JP 2012-152888 filed in the Japan Patent Office on Jul. 6, 2012, the entire content of which is hereby incorporated by reference.

What is claimed is:

1. A power management device comprising:
a storage unit configured to hold a correspondence relationship between first identification information held by a power supply target and second identification information held by a user in advance; and
a power management unit configured to issue a power supply instruction to a power supply device that supplies power to the power supply target based on the correspondence relationship between the first identification information and the second identification information.

2. The power management device according to claim 1, wherein the power management unit issues the power supply instruction by referring to the correspondence relationship between the first identification information and the second identification information in response to an inquiry of power supply permission/rejection for the power supply target issued from the power supply device.

3. The power management device according to claim 1, wherein the power management unit grants a right to use power to the second identification information and issues the power supply instruction so that the power is supplied to the power supply target having the first identification information associated with the second identification information to which the right to use the power has been granted.

4. The power management device according to claim 1, wherein the first identification information and the second identification information are associated by the user in advance.

5. The power management device according to claim 1, wherein the second identification information is assigned to belongings of the user.

6. The power management device according to claim 1, wherein the second identification information is information regarding the user.

7. A power supply device comprising:
an information acquisition unit configured to acquire first identification information held by a power supply target;
an inquiry unit configured to issue an inquiry of permission/rejection of power supply for the power supply target to a power management device based on the first identification information; and
a power supply unit configured to supply power to the power supply target according to a power supply instruction from the power management device in response to the inquiry.

8. The power supply device according to claim 7, wherein the information acquisition unit acquires the first identification information using RFID over power line technology.

9. The power supply device according to claim 7, wherein the information acquisition unit is integrated with the power supply unit.

10. The power supply device according to claim 7, wherein the power supply unit supplies the power to the power supply target using non-contact power feeding.

11. A power supply system comprising:
a power management device; and
a power supply device,
wherein the power management device includes
a storage unit configured to hold a correspondence relationship between first identification information held by a power supply target and second identification information held by a user in advance, and
a power management unit configured to issue a power supply instruction to the power supply device that supplies power to the power supply target based on the correspondence relationship between the first identification information and the second identification information, and
wherein the power supply device includes
an information acquisition unit configured to acquire the first identification information held by the power supply target,
an inquiry unit configured to issue an inquiry of permission/rejection of power supply for the power supply target to the power management device based on the first identification information, and
a power supply unit configured to supply power to the power supply target according to the power supply instruction from the power management device in response to the inquiry.

12. A power management method comprising:
holding a correspondence relationship between first identification information held by a power supply target and second identification information held by a user in advance; and
issuing a power supply instruction to a power supply device that supplies power to the power supply target based on the correspondence relationship between the first identification information and the second identification information.

13. A power supply method comprising:
acquiring first identification information held by a power supply target;
issuing an inquiry of permission/rejection of power supply for the power supply target to a power management device based on the first identification information; and
supplying power to the power supply target according to a power supply instruction from the power management device in response to the inquiry.
